(19) United States
(12) Patent Application Publication
(10) Pub. No.: US 2003/0231252 A1
(43) Pub. Date: Dec. 18, 2003

(54) Image sensor with improved noise cancellation

(75) Inventors: Keith Findlater, Edinburgh (GB); Jonathan Ephriam David Hurwitz, Edinburgh (GB)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics Ltd, Buckinghamshire (GB)

(21) Appl. No.: 10/325,646

(22) Filed: Dec. 18, 2002

(30) Foreign Application Priority Data
Dec. 19, 2001 (EP) 01310582.0

(51) Int. Cl. H04N 5/335

(52) U.S. Cl. 348/297

(57) ABSTRACT

A solid state image sensor may include a pixel array of an active pixel type including three transistors and a photodiode for each pixel. Pixel reset values may be read out one row at a time and stored in a frame store. Pixel signal values may also be read out a row at a time. The stored reset values may be subtracted, for example, by a read/write/modify circuit to remove kTC noise. The readout of the reset and signal values may be interleaved, and the offset between read and reset for each row may be selected to control frame exposure.

### FIELD OF THE INVENTION

The present invention relates to the field of image sensors, and, more particularly, to solid state image sensors having improved noise cancellation.

### BACKGROUND OF THE INVENTION

The present invention is particularly applicable to active pixel image sensors (APS) with three transistors and a photodiode for each pixel, as illustratively shown in FIG. 1. A photodiode 10 is used as a capacitor on which photo-generated carriers are integrated. Typically, the photodiode 10 is reset to a voltage Vrt using a transistor M2, discharged by the photo-current, and read via a transistor M3. Reset noise, also known as kTC noise, results from the sampling of the thermal noise from the transistor M2 onto the pixel capacitance when the photodiode 10 is reset. This noise is time-varying, as the photodiode voltage will be different each time it is reset.

The noise introduced during a single reset has a root mean square voltage of:

$${V}_{reset} = \sqrt{( kT / C )} ,$$

if the reset transistor is operating in a strong inversion (i.e., a hard reset) during reset, where C is the pixel photodiode capacitance, k is Boltzmann's constant, and T is the absolute temperature. If the reset transistor is operated in a weak inversion (i.e., a soft reset), the noise is reduced by a factor of \sqrt{2}.

It is common to correct for fixed pixel offsets by storing the read voltage, storing the reset voltage, and taking the difference between these two. While this technique removes the fixed pixel offsets, such as from the pixel source follower transistor threshold voltage variation, it introduces two sources of reset noise. This is because the pixel value after integration includes the noise from the previous reset, and when the pixel is reset after integration the reset noise from the second reset is not correlated with the noise from the reset prior to integration. This technique is commonly referred to as “correlated-double-sampling,” although this is technically incorrect since the temporal noise in the two samples is not in fact correlated. Accordingly, this technique is referred to herein as “uncorrelated-double-sampling” (UDS).

It can be shown that in UDS the RMS value of the total noise in the output signal is \sqrt{(2kT/C)}. For a pixel photodiode capacitance of 4 fF, a value of 1.44 mV at the photodiode for this noise source is obtained. Under low light conditions this can be the dominant noise source in the image and causes significant degradation in signal-to-noise ratio. It is therefore very desirable to eliminate this noise source.

Reset and read timing for UDS is illustrated in FIG. 2, and a typical UDS readout circuit and the readout of an image frame in standard UDS are illustratively shown in FIGS. 3 and 4, respectively. The two values at t₂ and t₃ are close together in time, typically 1-10 μs apart, while t₁ and t₂ could be up to an entire frame time apart. This allows a single row of sample and hold capacitors, such as the capacitors 12 (FIG. 3), to be used to store the values at t₂ and t₃ and subtract them during readout from the image sensor.

It is not possible to store the value from t₁ in this way, since between time t₁ and t₂ there will be many more resets for the pixels of the other rows in the array, and these values would have to be stored as well. As there are only two sample and hold capacitors per row, there is nowhere to store the other values. Adding enough sample and hold capacitors to store all the required values is not feasible due to the large size of these capacitors.

U.S. Pat. No. 5,926,214 to Denyer et al. discloses a method of performing true correlated-double-sampling. In this arrangement, the actual reset value of every pixel is stored before integration and then subtracted from the read value of that pixel. However, the method disclosed in Denyer et al. relies upon the use of a mechanical shutter, which adds cost and complexity to the camera. Further, in certain cases the use of a mechanical shutter may not be possible due to, for example, space constraints.

### SUMMARY OF THE INVENTION

An object of the invention is to enable true correlated double sampling without the use of mechanical elements.

Accordingly, the present invention provides a solid state image sensor as defined in claim 1. Other aspects of the invention provide a camera including such a solid state image sensor, and a method of operating a solid state image sensor as defined in claim 6.

### BRIEF DESCRIPTION OF THE DRAWINGS

An embodiment of the present invention will now be described, by way of example only, with reference to the drawings, in which:

FIG. 1 (previously described) is a schematic circuit diagram of an active pixel image sensor in accordance with the prior art;

FIG. 2 (previously described) is a signal diagram illustrating reset and read timing for UDS in accordance with the prior art;

FIG. 3 (previously described) is a schematic block diagram of a UDS readout circuit in accordance with the prior art;

FIG. 4 (previously described) is a schematic diagram of the readout of an image frame in standard UDS in accordance with the prior art;

FIG. 5 is a schematic diagram of the readout of an image frame in accordance with one embodiment of the present invention;

FIG. 6 is a timing diagram illustrating reset and read timings for pixel array rows in accordance with the present invention;

FIG. 7 is a schematic block diagram illustrating output data frames under different exposures in accordance with the present invention;

FIG. 8 is a schematic block diagram of an image sensor system in accordance with the present invention; and

FIG. 9 is a schematic block diagram illustrating an embodiment of the invention for implementing exposure control.

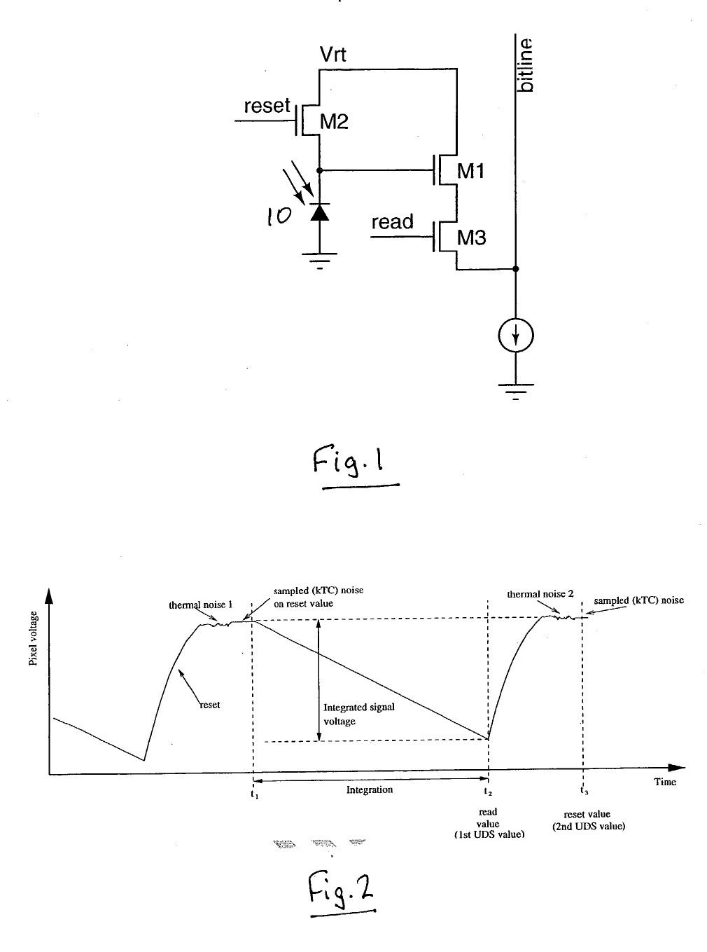

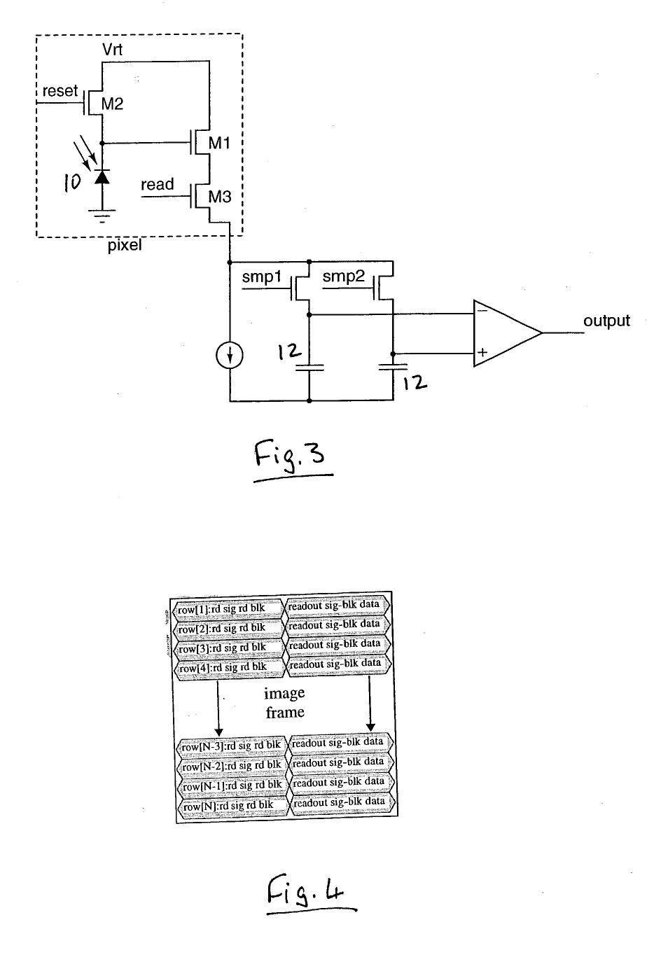

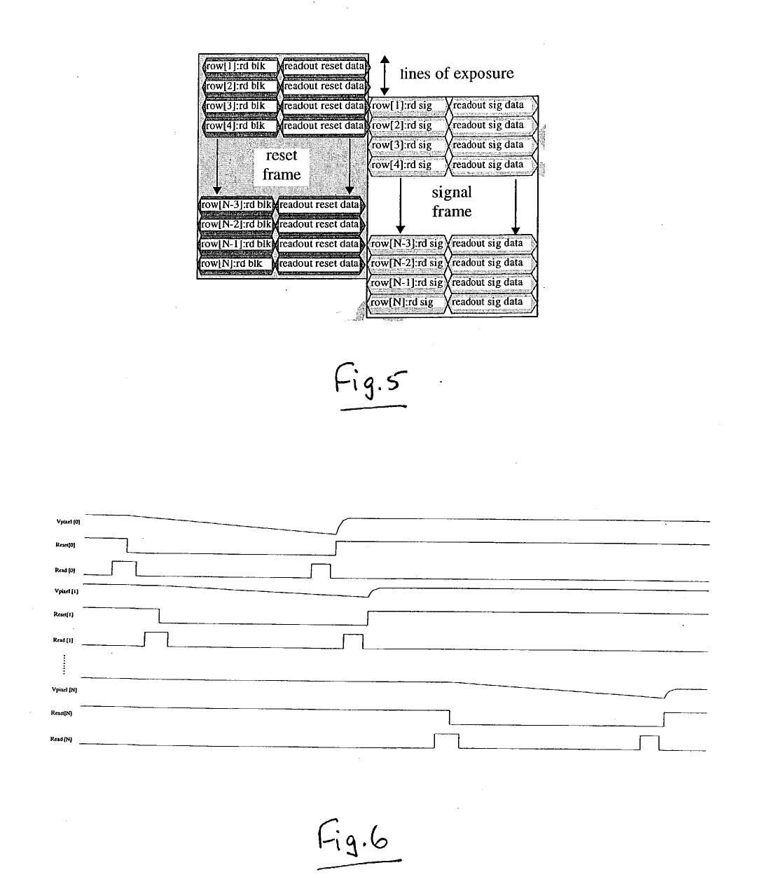

### DETAILED DESCRIPTION OF THE PREFERRED EMBODIMENTS

The present invention allows reset noise to be cancelled without the use of a mechanical shutter. A rolling electronic exposure control is implemented using the pixel reset transistors. This is the same as in standard three-transistor active pixel sensor timing. However, the timing of the sensor readout is arranged to allow both read and reset data to be interleaved, which allows reset noise cancellation to be performed while giving control over exposure of the pixels.

Turning now to FIGS. 5 and 6, an example is illustratively shown in which the readout of signal data for a given row is offset by three line periods from the equivalent reset data. That is, signal data for row [1] is read out after the reset data for row [3], signal data for row [2] is read out after the reset data for row [4], and so on.

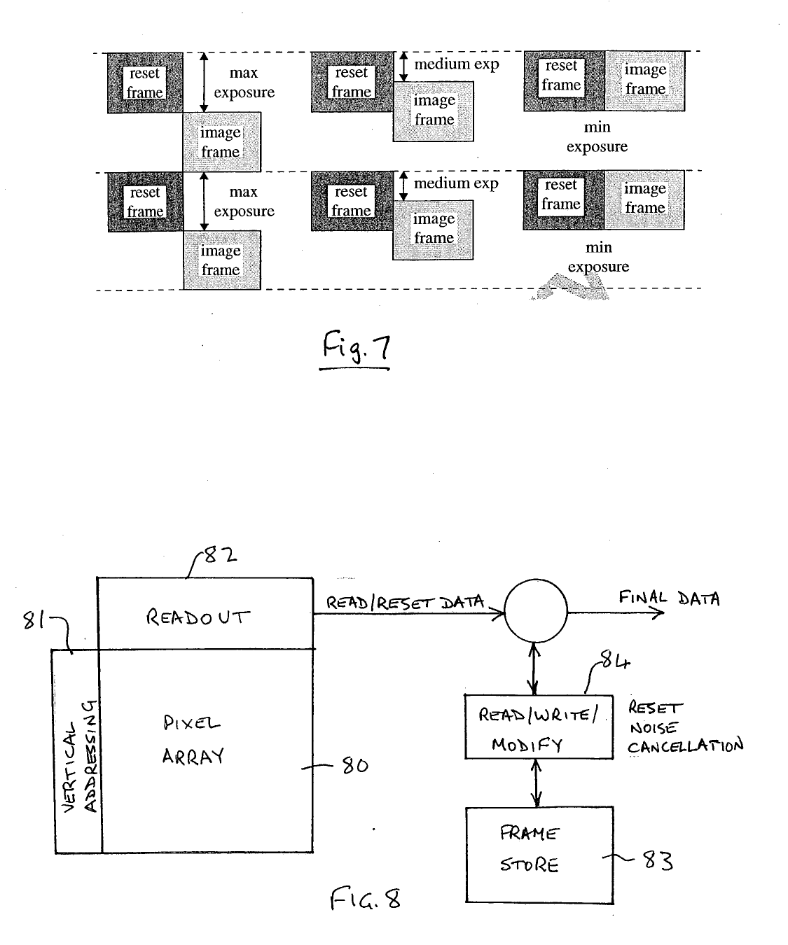

As seen in FIG. 7, the timing offset between the readout of reset and signal data for any given line can be varied from a whole frame, giving maximum exposure, to zero (i.e., signal data immediately following reset data) for minimum exposure. This requires the ability to store an entire frame of pixel reset values.

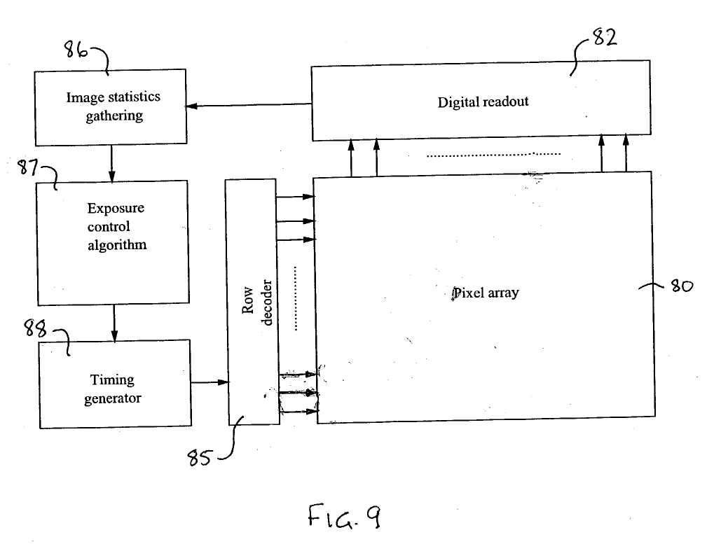

One implementation of the system of the present invention is illustratively shown FIG. 8. The pixel array 80 has vertical addressing circuits 81 and readout circuits 82 of a known type. Read and reset data are stored in a frame store memory 83. A read/modify/write circuit 84 is used to perform the subtractions required to cancel the noise. Preferably, the frame store 83 is in the form of a dynamic RAM, and the readout from the pixel array uses a per-column analog-to-digital converter architecture.

The entire system shown in FIG. 8 could be implemented on a single chip. Alternatively, the system could be implemented on more than one chip, for example, with the frame store forming a separate chip. A further possibility is to implement the frame store and/or the read/write/modify circuit with software on a general purpose computing circuit.

Referring now to FIG. 9, one example of exposure control in the form of a digital logic control loop is illustratively shown. The pixel array 80 and readout circuit 82 are as described above. The reset and readout pulses are provided by a row decoder 85 (a shift register architecture could also be used) which is controlled by a digital circuit. Statistics on the image data are gathered at 86. These are used as inputs to an algorithm circuit 87 operating an exposure control algorithm to control a timing generator 88. The timing generator 88 sets the gap between the reset and read control pulses according to the exposure value from the algorithm. Alternatively, exposure control could be implemented by software.

The embodiments described above offset the reset and read times by a complete number of pixel rows. This is convenient, but not essential. The offset could include partial rows, and could be defined as a time period rather than a number of rows.

The embodiments described above also include direct reset subtraction from readout values for a given pixel. Direct subtraction may be replaced or augmented by mathematical manipulation of the reset and/or read data. For example, the reset and read data could undergo compression before subtraction occurs.

In the present invention, because the actual pixel reset noise is subtracted from the signal value, the output is the true integrated photocurrent with kTC noise eliminated. A secondary advantage is that any other noise injected via the voltage supply to the pixel is also stored and eliminated, which greatly improves the power supply noise immunity of the system.

The requirement for a frame store may be seen as a disadvantage over alternative techniques such as the four-transistor pinned photodiode (4-T) pixel. However, the invention is compatible with standard CMOS technology, whereas the 4-T pixel requires a specialized manufacturing technology.

That which is claimed is:

1. An image sensor circuit arrangement comprising a solid state image sensor having an image plane formed by an array of pixels, each pixel comprising a light-sensitive capacitance, reset means for resetting the capacitance from a given voltage source, first readout means for reading out the pixel reset value, and second readout means for reading out the pixel signal value;
the image sensor circuit arrangement further comprising a frame store, a readout circuit for transferring pixel reset values to the frame store, and subtraction means for subtracting the stored reset value of each pixel from the readout signal value of the same pixel;
and in which the readout circuit is operative to interleave signal values from rows of pixels with reset values from rows of pixels with a selected offset between the reset and signal values of each row whereby to control exposure.

2. The circuit arrangement of claim 1, in which the frame store, the readout circuit and the subtraction means form part of a single integrated circuit with the image sensor.

3. The circuit arrangement if claim 1, in which the frame store is located in a solid state circuit separate from the image sensor.

4. The circuit arrangement of claim 1, in which the frame store is implemented by software on a computing means.

5. The circuit arrangement of any preceding claim, in which said offset is a number of rows selected from zero to the entire frame.

6. The circuit arrangement of any preceding claim, in which the frame store is capable of holding the reset values of the pixels of the entire frame.

7. The circuit arrangement of any preceding claim, in which the subtraction means is a read/modify/write circuit.

8. The circuit arrangement of any preceding claim, in which the readout circuit includes, for each row, a pair of sample-and-hold capacitors and a digital to analog converter.

9. A method of operating a solid state image sensor having an image field comprising an array of pixels, each pixel comprising a light-sensitive capacitance, and reset means for resetting the capacitance from a given voltage source; the method comprising:
(a) resetting the pixels of a first row;
(b) reading out and storing the pixel reset values of the row;
(c) repeating steps (a) and (b) for subsequent rows;
(d) reading out the signal values of the pixels of the first row interleaved with the reading out of rows of pixel reset values, said reading out being separated from the reading out of the pixel reset values of the first row by a selected time;
(e) repeating step (d) for subsequent rows; and
(f) subtracting the stored reset value of each pixel from the signal value of the same pixel and outputting the result as a noise-cancelled signal value.

10. A method according to claim 9, in which said selected time is a selected number of rows of readout.

11. A method according to claim 10, in which said selected number of rows can be selected within the range zero to whole frame.

12. A method according to any of claims 9 to 11, in which said subtraction is replaced or augmented by mathematical manipulation of the reset and/or signal data.

13. A camera including an image sensor circuit arrangement as claimed in any of claims 1 to 8.
